(19) United States
(12) Patent Application Publication
(10) Pub. No.: US 2002/0026377 A1
(43) Pub. Date: Feb. 28, 2002

(54) Gift arrangement method and system thereof using internet

(75) Inventor: Yoshiharu Takahashi, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: NET CORPORATION CO., LTD., Kyoto-shi (JP)

(21) Appl. No.: 09/915,333

(22) Filed: Jul. 27, 2001

(30) Foreign Application Priority Data
Jul. 28, 2000 (JP) P2000-229740

(51) Int. Cl. G06F 17/60

(52) U.S. Cl. 705/26

(57) ABSTRACT

Arrangement for sending a gift is made easy for a sender and arrangement for receiving the gift is made easy for a receiver.

Sending of a gift is arranged by a sender 20 who accesses a gift center 10 via Internet, selects a gift and specifies an E-mail address or a terminal address capable of sending and receiving E-mails of a receiver 30. A gift center 10 distributes the E-mail to the receiver 30 via Internet, prompting the receiver to access the gift center to look through the product image of the gift from the sender 20. When the receiver 30 receives the gift from the sender 20, reception of the gift is arranged by specifying the receiving method to the gift center 10.

### BACKGROUND OF THE INVENTION

1. Field of the Invention

The present invention relates to a gift arrangement method using Internet and a gift arrangement system using Internet.

2. Description of the Related Art

Generally, when sending a gift, a sender selects a gift, and informs the address and name to be sent, contact method and the like to a gift handling company, and the person who is to receive this gift (receiver) delivered by the gift handling company receives it at the address informed to the gift handling company by the sender.

### SUMMARY OF THE INVENTION

However, with this method in the related art, the sender has to know such as the address, name and contact method of the person who is to receive the gift, and at the time of arranging the gift, the sender has to inform this information accurately to the gift handling company. Therefore, there is a problem in that arrangement of gifts requires considerable time and labor for the sender.

Moreover, the place where the receiver receives the gift is limited to the address informed to the gift handling company by the sender. Therefore, for example, in the case where the receiver returns to his/her native place for the summer holidays, the receiver cannot receive the gift. Therefore, there is another problem in that arrangement for receiving the gift may sometimes be inconvenient for the receiver.

It is an object of the present invention to provide a gift arrangement method and system thereof using Internet, which can eliminate problems in the related art and can activate the gift market in such a manner that arrangement for sending gifts becomes easy for senders, and arrangement for receiving the gift becomes also easy for receivers, thereby preparation and delivery of gifts can be smoothly performed at a favorable opportunity, avoiding waste of time.

According to a first aspect of the present invention, there is provided a method for arranging a gift using Internet, wherein a sender accesses a homepage of a gift center via Internet, registers as a member, selects a gift, and specifies an E-mail address or a terminal address of a receiver capable of receiving and sending an E-mail, thereby arranges for sending a gift, and the gift center send an E-mail to the receiver via Internet, prompting the receiver to access the homepage of the gift center to look through the product image of the gift from the sender, and in the case where the receiver receives the gift from the sender, the receiver specifies the receiving method to the gift center, thereby arranging the reception of the gift.

According to a second aspect of the present invention, there is provided a method for arranging a gift using Internet, wherein the sender accesses a home page of a gift center via Internet, registers as a member, selects a gift, downloads a product image of the gift and transmits an E-mail attached with the product image to a receiver via Internet, thereby arranging the delivery of the gift, and in the case where the receiver receives the gift from the sender, the receiver specifies the receiving method to the gift center via Internet, thereby arranging the reception of the gift.

According to a third aspect of the present invention, there is provided a system for arranging a gift using Internet, wherein a server of a gift center is provided with a homepage, a gift product information file, a product image file and a member database, the gift center sends an E-mail to the receiver, based on the gift selected by the sender who accessed the homepage from a member-registered client, and the E-mail address or a terminal address capable of receiving and sending E-mails of the receiver specified by the sender, and the receiver reads the E-mail, accesses the homepage to look through the product image of the gift from the sender, and when the receiver receives the gift, the receiver specifies the receiving method to the gift center.

According to a fourth aspect of the present invention, there is provided a system for arranging a gift using Internet, wherein a server of a gift center is provided with a homepage, a gift product information file, a product image file and a member database, a sender accessing the homepage from a member-registered client downloads the product image of the selected gift and transmits an E-mail attached with the product image to the receiver, and when receiving the gift from the sender, the receiver specifying the receiving method to the gift center.

### BRIEF DESCRIPTION OF THE DRAWINGS

FIG. 1 is a block diagram showing one embodiment of a gift arrangement system using Internet;

FIG. 2 is a flowchart showing the arrangement operation for sending a gift when the gift in FIG. 1 is a single product;

FIG. 3 is a flowchart showing the arrangement operation for sending a gift when a plurality of gifts is selected in FIG.

FIG. 4 is a flowchart showing the arrangement operation for receiving a gift when the gift in FIG. 1 is a single product;

FIG. 5 is a flowchart showing the arrangement operation for receiving a gift when a plurality of gifts is selected in FIG. 1;

FIG. 6 is a block diagram showing another embodiment of a gift arrangement system using Internet;

FIG. 7 is a flowchart showing the arrangement operation for sending a gift when the gift in FIG. 6 is a single product;

FIG. 8 is a flowchart showing the arrangement operation for sending a gift when a plurality of gifts is selected in FIG. 6;

FIG. 9 is a flowchart showing the arrangement operation for receiving a gift when the gift in FIG. 6 is a single product; and

FIG. 10 is a flowchart showing the arrangement operation for receiving a gift when a plurality of gifts is selected in FIG. 6.

### DESCRIPTION OF THE PREFERRED EMBODIMENTS

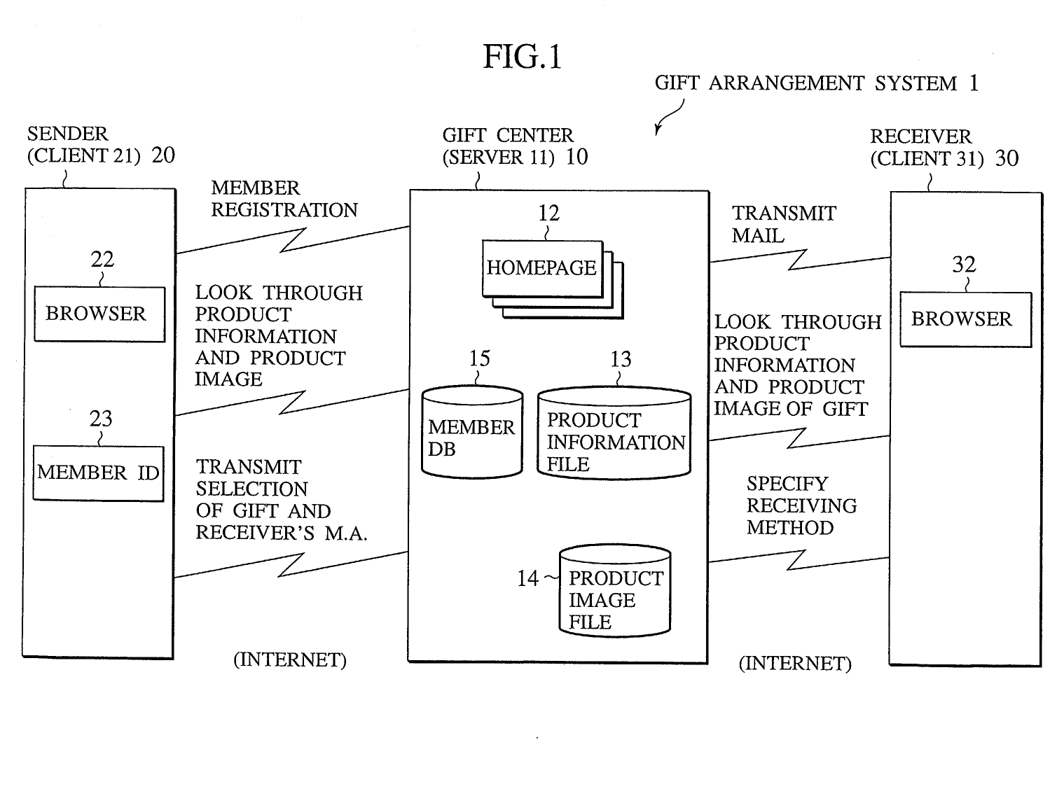

FIG. 1 is a block diagram showing an embodiment of a gift arrangement system using Internet, according to the present invention. This gift arrangement system 1 interconnects a gift center 10, a sender 20 and a receiver 30 via Internet, so that arrangement for sending a gift by the sender 20 and arrangement for receiving the gift by the receiver 30 are respectively performed via the gift center 10.

A server 11 of the gift center 10 is provided with a homepage 12, a gift product information file 13, an image file 14 related to the appearance and structure of the product and a member database (DB) 15, and a client 21 of the sender 20 is provided with a browser 22 and an member ID 23. Also, a client 31 of the receiver 30 is provided with a browser 32.

<Arrangement of Sending a Gift>

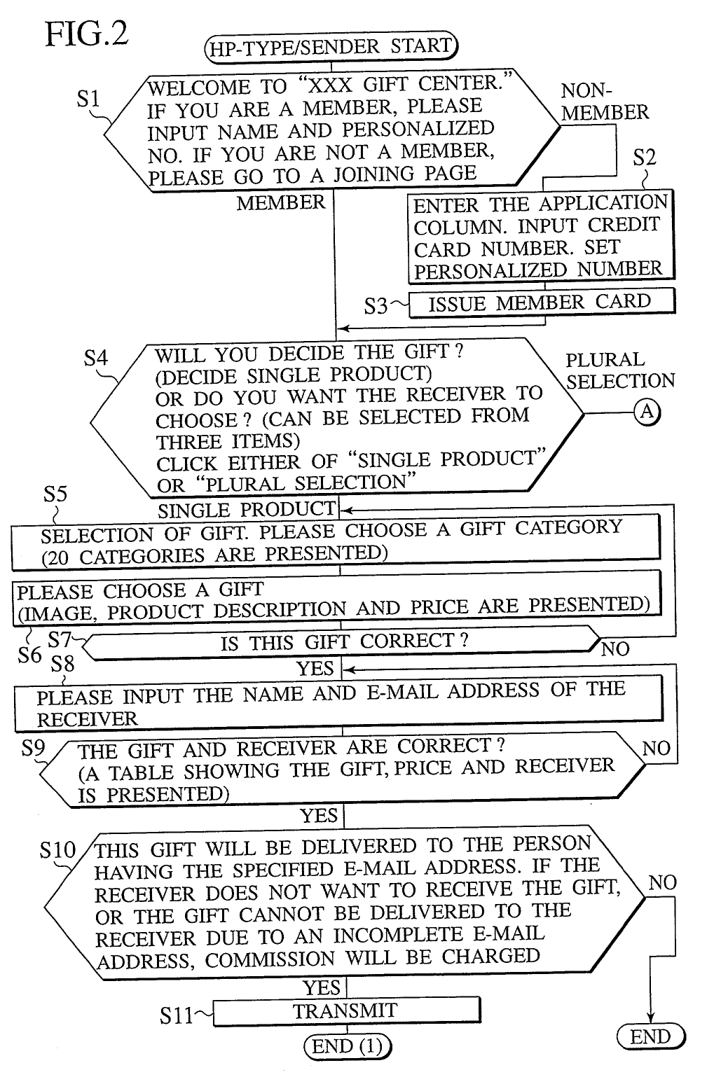

First, the arrangement operation for sending a gift by the sender 20 will be explained. As shown in FIG. 2, when the sender 20 operates the client 21 to access the server 11 of the gift center 10, a gift guidance screen of the gift center is displayed in step S1. Here, if the sender is a member, the sender inputs name and a personalized number (member ID). Then, in step S4, there is displayed a screen for asking the selection method, whether the sender selects a gift singly or the sender selects a plurality of gifts and the receiver chooses one of these.

On the other hand, if the sender is not a member, the sender performs a procedure necessary for becoming a member (step S2), and after confirmation, a member card is issued from the gift center 10 (step S3). The sender then inputs a personalized number (member ID) described on this member card, thereby the contents shown in step S4 are displayed on the screen.

When the sender 20 selects “single product”, seeing the screen shown in step S4, the category of the gift is displayed on the screen in step S5. When the sender 20 selects an optional category from 20 categories, a screen showing a gift list in the corresponding category is displayed in step S6. When the sender selects an optional product from the screen where images and product description and product prices are displayed, a confirmation screen is displayed in step S7, and if NO, the procedure returns to step S5, and if YES, the procedure proceeds to the next step S8.

In step S8, it is prompted to input the information of the receiver, and when the sender 20 inputs the name and E-mail address of the receiver 30, a confirmation screen of the contents is displayed in step S9. If NO, the procedure returns to step S8, and if YES, a screen for the final confirmation is displayed in step S10.

When the sender 20 sees the screen shown in step S10, understands the set contents and selects YES, the contents are confirmed, and the gift center 10 sends the E-mail to the receiver 30 (step S11). Thereby, the arrangement for sending the gift by the sender 20 is executed and completed.

On the contrary, in step S10, when the sender 20 sees the screen and selects NO, the gift center 10 does not execute the arrangement for sending the gift by the sender 20, and the procedure is completed.

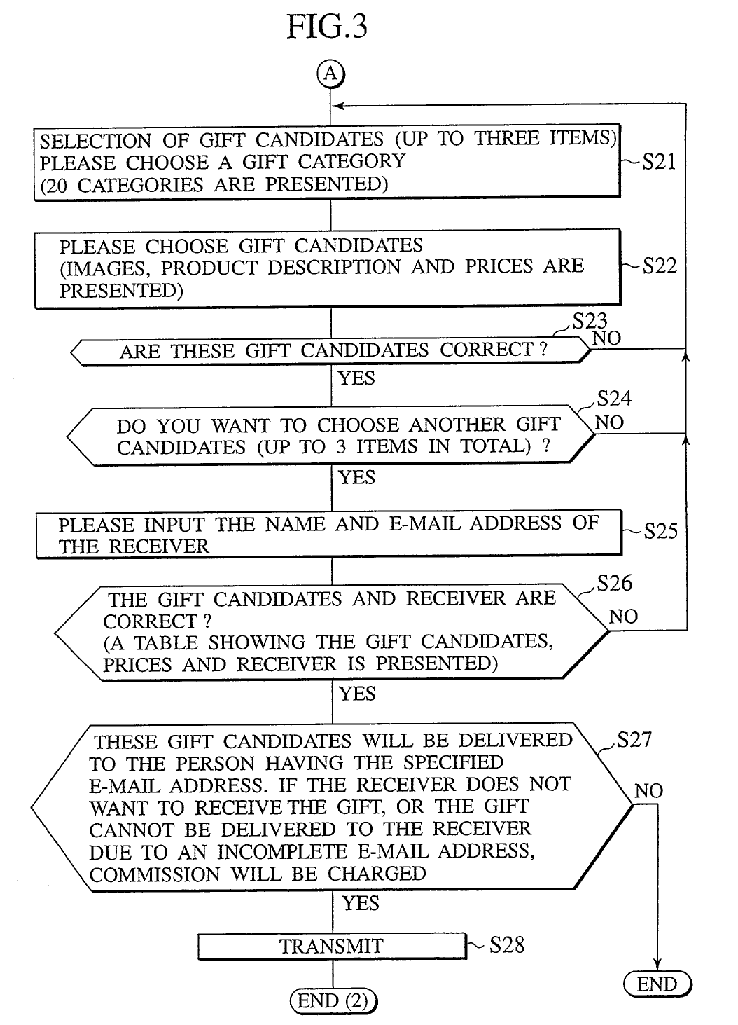

On the other hand, if the sender 20 sees the screen shown in step S4 and selects “plural”, a screen related to the gift category is displayed in step S21, as shown in FIG. 3. For example, when the sender 20 selects an optional category from 20 categories, the information including the gift candidates is displayed on the screen in step S22.

When the sender 20 selects an optional product from the screen where images, product description and product prices are displayed, a screen for confirming the set contents is displayed in step S23, and if NO, the procedure returns to step S21. If the sender 20 agrees the set contents and selects YES, a screen for confirming whether the sender 20 wants to select and add another product is displayed in step S24. In step S24, if YES is selected, the procedure returns to step S21, and if NO, a screen requesting to input the information of the receiver is displayed in step S25. In this embodiment, gifts can be selected up to three, but this number is optional. Moreover, the upper limit of the total price is determined, and an optional number of gifts may be selected within that range.

When the sender 20 inputs the name and E-mail address of the receiver 30, temporary contents of the selected gift candidates is displayed on the screen in step S26, and if NO, the procedure returns to step S21, and if YES, the procedure proceeds to step S27, where the contents are settled. In order to modify the contents such as a part of the gift candidates or the receiver, a routine (not shown) for jumping to step S21 or step S25 may be provided.

In step S27, the final confirmation screen is displayed, and when the sender 20 selects YES, the gift center 10 transmits an E-mail to the receiver 30 (step S28), thereby the arrangement for sending a gift by the sender 20 is executed and completed.

On the contrary, when the sender 20 selects NO, seeing the screen in step S27, then, the gift center 10 does not execute the arrangement for sending the gift by the sender 20, and the procedure is completed.

<Arrangement for Receiving a Single Gift>

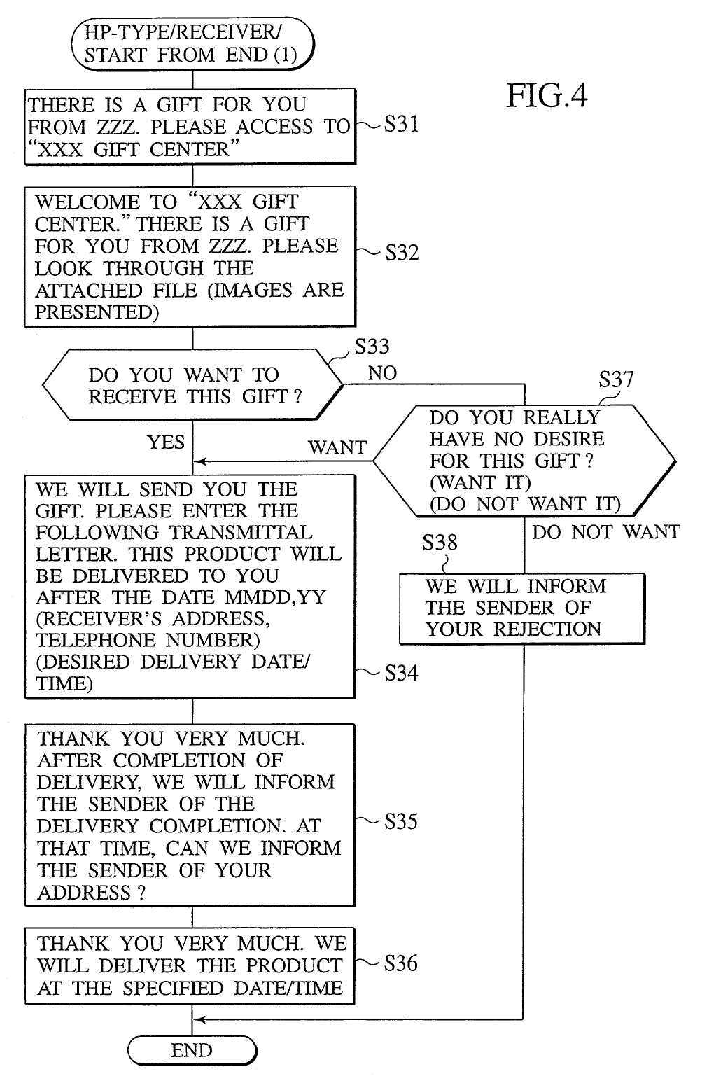

Next, the arrangement operation for receiving the gift by the receiver 30 in the case where the sender 20 selects the “single product” in FIG. 2 will be explained. As shown in FIG. 4, when the receiver 30 operates the client 31 and receives the E-mail about the gift, a screen prompting the access to the gift center is displayed in step S31, and when the receiver 30 operates the client 31 in response to the display and accesses the server 11 of the gift center 10, the guidance screen provided by the gift center is displayed in step S32, and subsequently in step S33, a screen for confirming the intention of receiving the gift is displayed.

When the receiver 30 sees the sender 20 and the image of the gift (step S33), and selects YES, the contents shown in step S34 is displayed on the screen, and when the receiver 30 specifies the gift receiving method, a confirmation screen is displayed in step S35. Subsequently in step S36, the final confirmation screen is displayed, and the gift center 10 accepts the arrangement for receiving the gift by the receiver 30 and completes the procedure.

On the other hand, if the receiver 30 sees the sender 20 and the image of the gift (step S33), and selects NO, a reconfirmation screen is displayed in step S37, and if the receiver selects “want”, the contents shown in step S34 are displayed on the screen. When the receiver 30 specifies the receiving method of the gift, the gift center 10 accepts the arrangement for receiving the gift by the receiver 30 and completes the procedure.

On the contrary, if the receiver 30 sees the screen shown in step S37, and selects “do not want”, the contents shown in step S38 are displayed on the screen, and the gift center 10 informs the sender 20 that the receiver 30 does not want to receive the gift, and completes the procedure.

<Arrangement for Receiving a Gift by Selecting from a Plurality of Products>

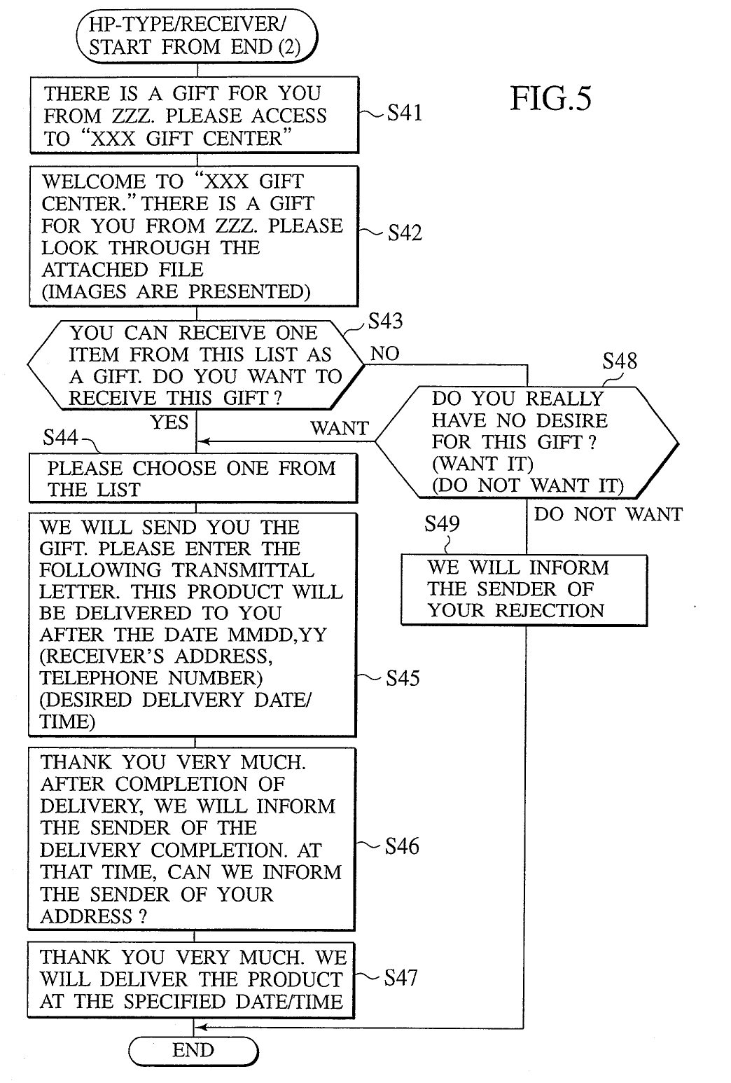

The arrangement operation for receiving the gift by the receiver 30 in the case where the sender 20 selects the “plural products” in FIG. 3 will be explained. As shown in FIG. 5, when the receiver 30 operates the client 31 and receives the E-mail, a screen prompting the access to the gift center is displayed in step S41, and when the receiver 30 operates the client 31 to access the server 11 of the gift center 10, the guidance screen is displayed in step S42, and subsequently in step S43, a screen for confirming the intention of receiving the gift is displayed.

When the receiver 30 sees the sender 20 and the list of images of the gift (step S43), and selects YES, it is judged that the receiver has an intention to receive the gift, and a screen for prompting the receiver to select a product is displayed in step S44. When the receiver 30 selects one product from the gift list, a screen for presenting the gift receiving method is displayed in step S45. When the receiver 30 specifies the gift receiving method, a screen for sounding out the delivery guidance is displayed in step S46. Subsequently in step S47, the confirmation screen is displayed, and the gift center 10 accepts the arrangement for receiving the gift by the receiver 30 and completes the procedure.

On the other hand, if the receiver sees the sender 20 and the list of images of the gift (step S43), and selects NO, a screen for confirming the intention again is displayed in step S48, and if the receiver 30 selects “want”, the contents shown in step S44 are displayed on the screen. When the receiver 30 selects one product from the list of gifts and specifies the receiving method of the gift, the gift center 10 accepts the arrangement for receiving the gift by the receiver 30 and completes the procedure.

On the contrary, if the receiver 30 sees the screen shown in step S48, and selects “do not want”, a response screen is displayed in step S49, and the gift center 10 informs the sender 20 that the receiver 30 does not want to receive the gift, and completes the procedure.

Another Embodiment

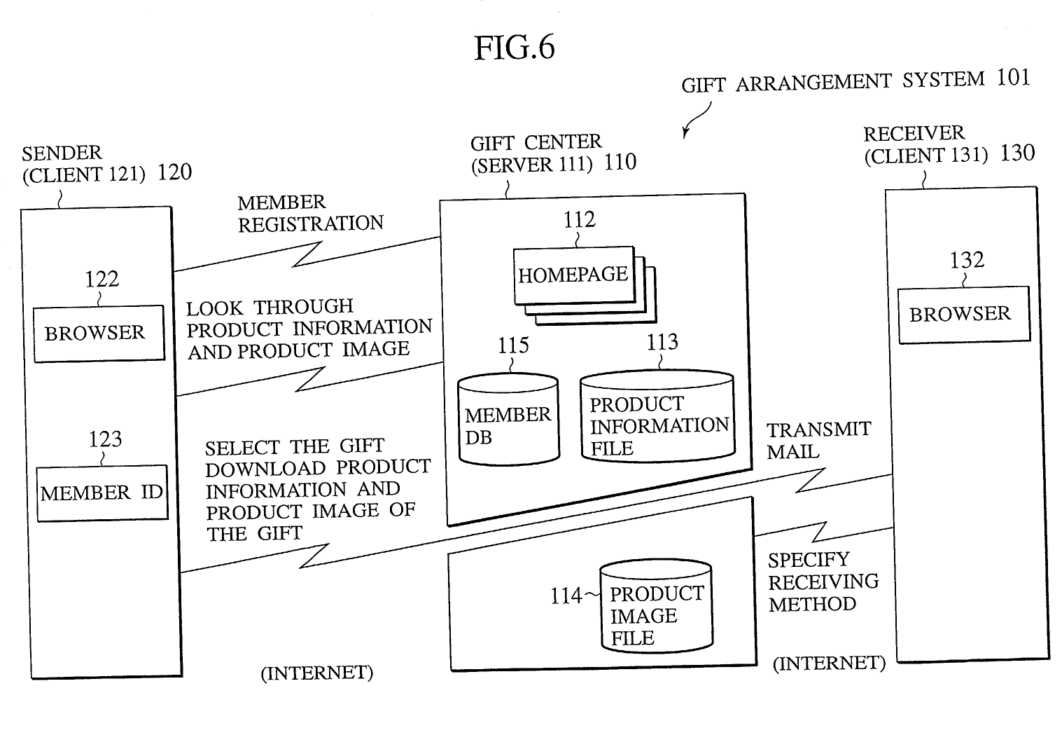

FIG. 6 is a block diagram showing another embodiment of a gift arrangement system using Internet according to the present invention. This gift arrangement system 101 interconnects a gift center 110, a sender 120 and a receiver 130 via Internet, so that arrangement for sending a gift is directly performed by the sender 120 to the receiver 130 and arrangement for receiving the gift is performed by the receiver 130 with respect to the gift center 110.

A server 111 of the gift center 110 is provided with a homepage 112, a product information file 113, a product image file 114 and a member database (DB) 115, and a client 121 of the sender 120 is provided with a browser 122 and an member ID 123. Also, a client 131 of the receiver 130 is provided with a browser 132.

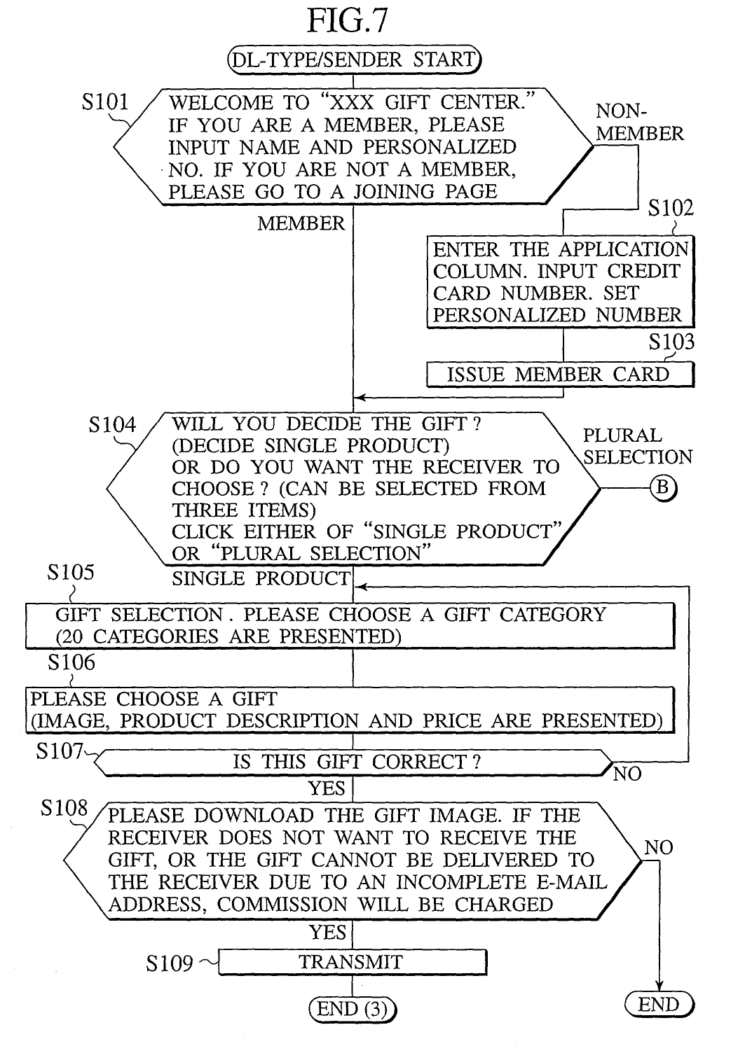

First, the arrangement operation for sending a gift from the sender 120 to the receiver 130 will be explained. As shown in FIG. 7, when the sender 120 operates the client 121 to access the server 111 of the gift center 110, a gift guidance screen is displayed in step S101.

If the sender is a member, the sender inputs name and a personalized number (member ID). Then, in step S104, there is displayed a screen for asking the gift selection method.

On the contrary, if the sender is not a member, the sender performs a procedure necessary for becoming a member (step S102), and after the procedure has been completed, a member card is issued from the gift center 110 (step S103). The sender then inputs a personalized number (member ID) described on this member card, thereby the contents shown in step S104 are displayed on the screen.

In step S104, the sender decides whether a single product is specified as a gift, or a plurality of products is to be proposed to the receiver for selection. When the sender 120 selects a “single product”, the contents shown in step S105 are displayed on the screen. When the sender 120 selects an optional category from 20 categories, information of the gifts is displayed on the screen in step 106. When the sender 120 selects an optional product from the screen where images, product description and product prices are displayed, a selection confirmation screen is displayed in step S107, and if NO, the procedure returns to step S105, and if YES, the final confirmation screen is displayed in step S108.

Seeing the screen shown in step S108, if the sender 120 selects YES and downloads the image of the gift, then, subsequently the sender 120 transmits an E-mail to the receiver 130 (step S109), thereby arrangement for sending a gift from the sender 120 to the receiver 130 is directly performed, and completed.

On the contrary, when the sender 120 sees the screen shown in step S108, and selects NO, the arrangement for sending the gift does not performed and the procedure is completed.

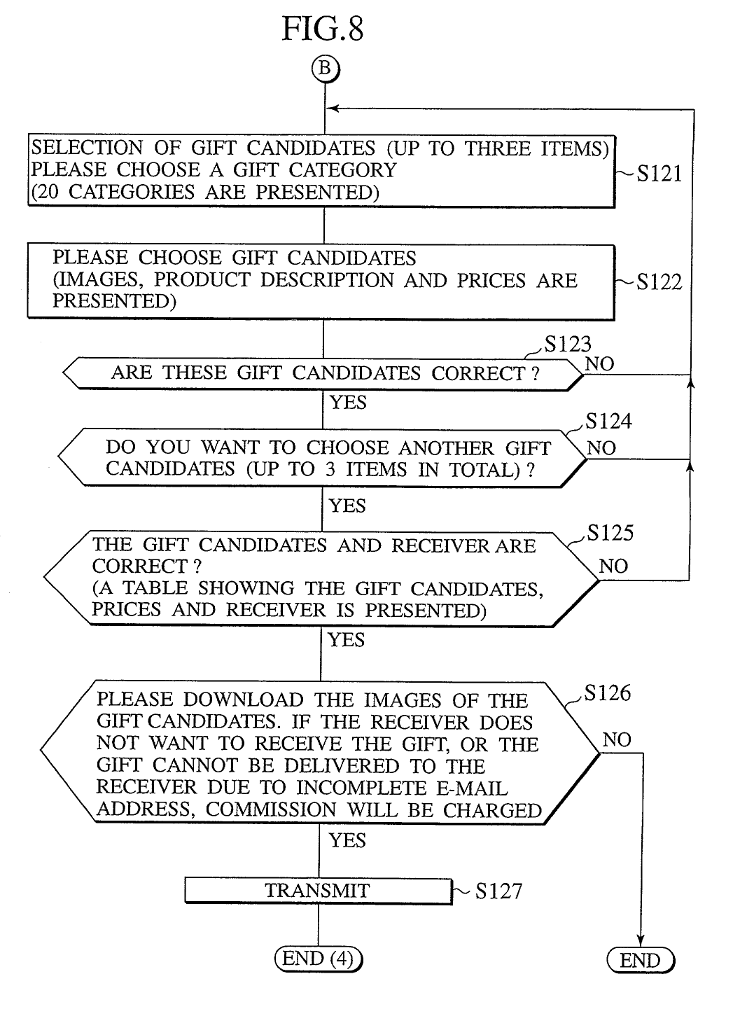

On the other hand, when the sender 120 sees the screen shown in step S104, and selects “plural”, the contents shown in step S121 are displayed on the screen, as shown in FIG. 8. For example, when the sender 120 selects an optional category from 20 categories, a gift candidate screen is displayed in step S122. In step S122, when the sender 120 selects an optional product from the screen where images, product description and product prices are displayed, a selection confirmation screen is displayed in step S123, and if NO, the procedure returns to step S121. If YES, a screen for addition and selection is displayed in step S124. In step S124, if YES, the procedure returns to step S121, and if NO, a screen for confirming addition is displayed in step S125. Then, if NO in step S125, the procedure returns to step S121, and if YES, a screen for confirming reception is displayed in step S126.

When the sender 120 sees the screen shown in step S126, and selects YES to download the images of the gift candidates, and subsequently transmits an E-mail to the receiver 130 (step S127), the arrangement for sending the gift from the sender 120 to the receiver 130 is directly performed and completed.

On the contrary, if the sender 120 selects NO, seeing the screen shown in step S126, the arrangement for sending the gift is not performed and the procedure is completed.

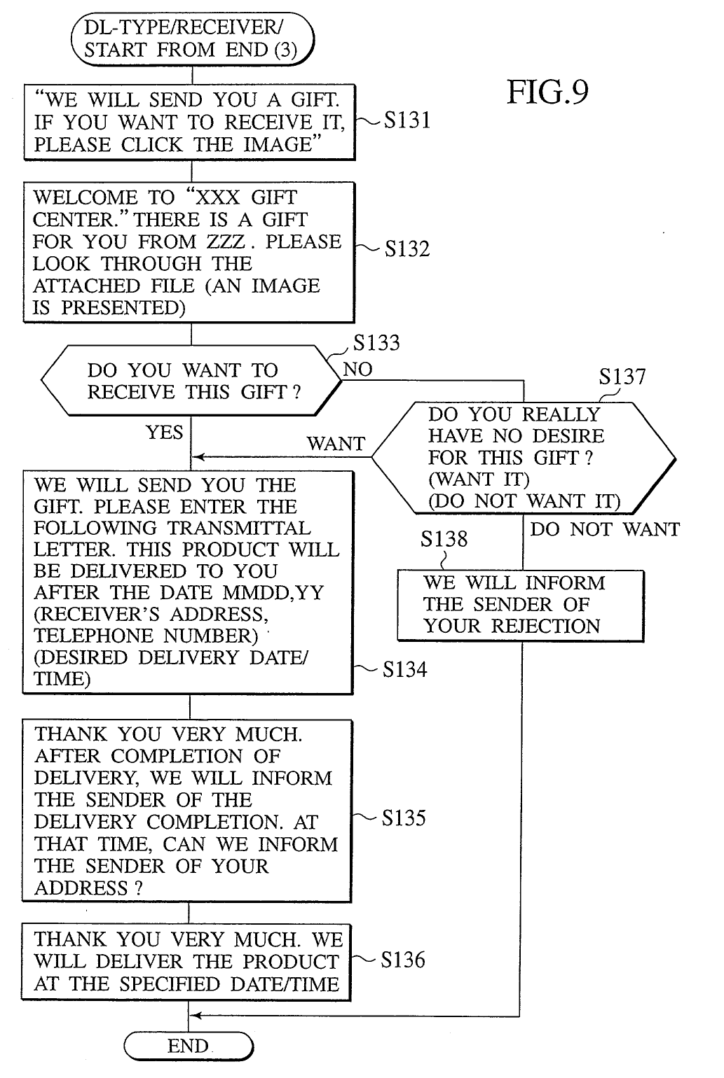

Next, the arrangement operation for receiving the gift by the receiver 130 in-the case where the sender 120 selects “single product” will be explained. As shown in FIG. 9, when the receiver 130 operates the client 131 and receives the E-mail about the gift, a screen indicating the offer of gift is displayed in step S131. When the receiver 130 clicks the image in response to the instruction on the screen, the server 111 of the gift center 110 is automatically connected for displaying the message of the gift center on the screen in step S132, and subsequently, a screen for confirming the intention to receive the gift is displayed in step S133.

When the receiver 130 sees the sender 120 and the image of the gift (step S133), and selects YES, a guidance screen is displayed in step S134. When the receiver 130 specifies the gift receiving method, a confirmation screen is displayed in step S135. Subsequently, the final confirmation screen is displayed in step S136, and the gift center 110 accepts the arrangement for receiving the gift by the receiver 130 and completes the procedure.

On the other hand, if the receiver 130 sees the sender 120 and the image of the gift (step S133), and selects NO, a reconfirmation screen is displayed in step S137, and if the receiver selects “want”, the contents shown in step S134 are displayed on the screen. When the receiver 130 specifies the gift receiving method, the gift center 110 accepts the arrangement for receiving the gift by the receiver 130 and completes the procedure.

On the contrary, if the receiver 130 sees the screen shown in step S137, and selects “do not want”, the final confirmation screen is displayed in step S138, and the gift center 110 informs the sender 120 that the receiver 130 does not want to receive the gift, and completes the procedure.

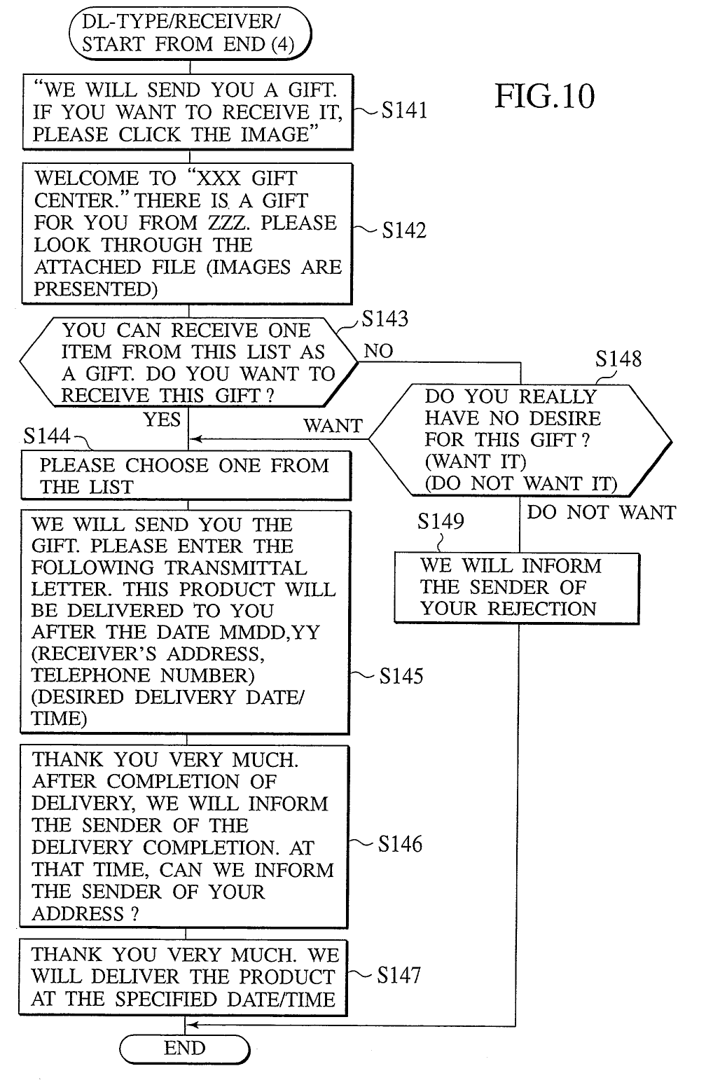

Next, the arrangement operation for receiving the gift by the receiver 130 in the case where the sender 120 selects the “Plural products” in FIG. 8 will be explained. As shown in FIG. 10, when the receiver 130 operates the client 131 and receives the E-mail, a gift guidance screen is displayed in step S141, and when the receiver 130 clicks the image in response to the instruction on the screen, the server 111 of the gift center 110 is automatically connected for displaying the contents shown in step S142 on the screen, and subsequently, a screen for confirming the intention to receive the gift is displayed in step S143.

When the receiver 130 sees the sender 120 and the list of gift images (step S143), and selects YES, candidates of the gift are displayed in step S144. When the receiver 130 selects one product from the list of the gifts, a confirmation screen is displayed in step S145.

When the receiver 130 specifies the gift receiving method, a confirmation screen is displayed in step S146, and subsequently, the final confirmation screen is displayed in step S147. Then, the gift center 110 accepts the arrangement for receiving the gift by the receiver 130 and completes the procedure.

On the other hand, if the receiver 130 sees the sender 120 and the list of gift images (step S143), and selects NO, a reconfirmation screen is displayed in step S148, and if the receiver selects “want”, the contents shown in step S144 are displayed on the screen. When the receiver 130 selects one product from the list of gifts and specifies the gift receiving method, the gift center 110 accepts the arrangement for receiving the gift by the receiver 130 and completes the procedure.

On the contrary, if the receiver 130 sees the screen shown in step S148, and selects “do not want”, the final confirmation screen is displayed in step S149, and the gift center 110 informs the sender 120 that the receiver 130 does not want to receive the gift, and completes the procedure.

Moreover, in the above embodiment, the E-mail address of the receiver 30 is used, but the present invention is not limited thereto, and for example, it is possible to use a terminal address such as a telephone number of a mobile phone having the E-mail function.

According to the present invention, sending of the gift can be arranged only by specifying an E-mail address or a terminal address capable of sending and receiving E-mails of the receiver, and therefore, arrangement for sending a gift can be easily performed. Moreover, the receiver can arrange reception of the gift only by specifying the receiving method according to the own convenience, and therefore, arrangement for receiving a gift can be easily performed. Furthermore, since arrangement of product can be scheduled, the gift center does not have to store a large amount of stocks, and sales charges does not considerably increase with an increase of sales. Therefore, a large cost reduction can be achieved for the medium and long term. The preparation and delivery of gifts can be smoothly performed at a favorable opportunity, avoiding waste of time. As a result, the gift market can be activated.

This application claims benefit of priority under 35USC §119 to Japanese Patent Applications No. 2000-229740, filed on Jul. 28, 2000, the entire contents of which are incorporated by reference herein. Although the invention has been described above by reference to certain embodiments of the invention, the invention is not limited to the embodiments described above. Modifications and variations of the embodiments described above will occur to those skilled in the art, in light of the teachings. The scope of the invention is defined with reference to the following claims.

What is claimed is:

1. A method for arranging a gift from a sender to a receiver using Internet, comprising steps of:
performing arrangement for sending the gift, the procedure of the arrangement including that the sender accesses a homepage of a gift center via Internet, registers as a member, selects a gift, and specifies an E-mail address or a terminal address capable of receiving and sending an E-mail of the receiver;
distributing of an E-mail to the receiver by the gift center via Internet, for prompting the receiver to access the homepage of the gift center to look through the product image of the gift from the sender; and
performing arrangement for receiving the gift, the procedure of the arrangement being such that when the receiver receives the gift from the sender, the receiver specifies the receiving method to the gift center.

2. A method for arranging a gift from a sender to a receiver using Internet, comprising steps of:
performing arrangement for sending the gift, the procedure of the arrangement including that the sender accesses a homepage of a gift center via Internet, registers as a member, selects a plurality of candidates of the gift, and specifies an E-mail address or a terminal address capable of receiving and sending an E-mail of the receiver;
distributing of an E-mail to the receiver by the gift center via Internet, for prompting the receiver to access the homepage of the gift center to look through the plurality of product images of the gift from the sender; and
performing arrangement for receiving the gift, the procedure of the arrangement being such that when the receiver receives the gift from the sender, the receiver selects one of the plurality of candidates and specifies the receiving method to the gift center.

3. A method for arranging a gift from a sender to a receiver using Internet, comprising steps of:
performing arrangement for sending the gift, the procedure of the arrangement including that the sender accesses a homepage of a gift center via Internet, registers as a member, selects a gift, downloads a product image of the gift and transmits an E-mail attached with the product image to the receiver via Internet; and
performing arrangement for receiving the gift, the procedure of the arrangement being such that when the receiver receives the gift from the sender, the receiver specifies the receiving method to the gift center via Internet.

4. A method for arranging a gift from a sender to a receiver using Internet, comprising steps of:
performing arrangement for sending the gift, the arrangement including that the sender accesses a homepage of a gift center via Internet, registers as a member, selects a plurality of candidates of the gift, downloads the product images of the plurality of candidates and transmits an E-mail attached with the product images to the receiver via Internet; and
performing arrangement for receiving the gift, the arrangement being such that when the receiver receives the gift from the sender, the receiver selects one of the plurality of candidates and specifies the receiving method to the gift center via Internet.

5. A method for arranging a gift according to any one of claims 1 to 4, wherein
when the sender is already a member registered in advance, the member registration is performed by inputting an ID instead of the member registration.

6. A system for arranging a gift from a sender to a receiver using Internet, comprising:
a server of a gift center, the server comprising a homepage, a gift product information file, a product image file, and a member database;
a client of the sender being member-registered to the gift center, the sender accessing the homepage from the client to select a gift and specifying an E-mail address or a terminal address capable of receiving an E-mail, and the server transmitting the E-mail to the receiver; and
a client of the receiver, the receiver reading the E-mail from the client of the receiver and accessing the homepage to look through the product image of the gift from the sender, and the receiver specifying the receiving method to the server from the client of the receiver when the receiver receiving the gift.

7. A system for arranging a gift from a sender to a receiver using Internet, comprising:
a server of a gift center, the server comprising a homepage, a gift product information file, a product image file, and a member database;
a client being member-registered to the gift center, the sender accessing the homepage from the client to select a gift, downloading the product image from the server and transmitting an E-mail attached with the product image to the receiver; and
a client of the receiver, the receiver specifying the receiving method to the server from the client of the receiver when the receiver receiving the gift.
